(19) United States
(12) Patent Application Publication
(10) Pub. No.: US 2013/0099762 A1
(43) Pub. Date: Apr. 25, 2013

(54) SYSTEMS AND METHODS FOR COUNTERACTING OVERVOLTAGE EVENTS

(71) Applicant: Emmanouil Terrovitis, Foster City, CA (US)

(72) Inventor: Emmanouil Terrovitis, Foster City, CA (US)

(73) Assignee: Qualcomm Atheros, Inc., San Jose, CA (US)

(21) Appl. No.: 13/278,022

(22) Filed: Oct. 20, 2011

(51) Int. Cl. G05F 1/00

(52) U.S. Cl. 323/271

(57) ABSTRACT

This disclosure involves methods and systems for reducing the voltage by a circuit such as a switching regulator during an overvoltage event by draining current from a voltage source when voltage exceeding a desired level is generated.

### FIELD OF THE PRESENT INVENTION

The present disclosure generally relates to suppression of overvoltage events in power circuits and more particularly to reducing voltage spikes in switching regulators.

### BACKGROUND OF THE INVENTION

Switching regulators, switching power supplies or switching mode power supplies (SMPS) all refer to an important class of circuits that are widely used to drive sophisticated electronic devices, particularly those depending upon microprocessors. Switching regulators offer high efficiency performance as compared to alternatives such as linear regulators while being able to accommodate rapidly changing loads and relatively high current draws over a wide range of operating conditions.

Switching regulators convert an input voltage to a different output voltage by employing ideally-lossless components such as switches, inductors and capacitors, resulting in high efficiency. Such designs generally feature an inductor switch-connected with transistors to the voltage source and an output load. A capacitor is wired in parallel with the output load to smooth the voltage output.

Even though the theoretical operation of the components used in switching regulators does not result in losses, practical implementations do suffer from various inefficiencies, including parasitic resistance, inductance and capacitance. A consequence of this parasitic inductance is the potential for overvoltage events including spikes in the output voltage that occur with each switching event. When these voltage spikes significantly exceed the designed voltage of the switching regulator, damage to sensitive circuits, such as those employing CMOS technologies, can occur.

Accordingly, it is desirable to counteract, minimize or otherwise reduce overvoltage events in switching regulators and other circuits that are subject to transient voltage spikes. This invention provides these and other advantages.

### SUMMARY OF THE INVENTION

In accordance with the above objects and those that will be mentioned and will become apparent below, this disclosure is directed to a switching regulator having an output with a desired voltage and a voltage clamp circuit, wherein the voltage clamp circuit comprises a first RC timing circuit connecting a voltage input to ground, a first switch connected to the input that is configured to be controlled by a desired output voltage signal from the first RC timing circuit such that the first switch is in an off state when the voltage input is balanced by the desired output voltage signal from the first RC timing circuit and is in an on state that generates a switching signal when the voltage input exceeds the desired output voltage signal by a threshold value, and a second switch that sinks current from the input to ground when placed in an on state by the switching signal Preferably, the first switch is a p-channel MOSFET and the second switch is an re-channel MOSFET.

In one aspect, the first RC timing circuit is formed by a first resistor and a capacitor connected in series between the input voltage and ground and wherein the desired output voltage signal is taken from a node of the first resistor and capacitor. Preferably, the first RC timing circuit has a time constant t within the range 0.1 to 100 microseconds. Also preferably, the switching regulator has a switching period and wherein the time constant t is in the range of approximately 10 to 100 times the switching period.

In another aspect, the voltage clamp circuit claim also includes a second RC timing circuit formed by a second resistor connecting a drain of the first switch to ground. Preferably, the second RC timing circuit has a time constant t related to the second resistor and a gate capacitance of the first switch. Also preferably, the time constant t is in the range of approximately 1 to 10 nanoseconds. Further, the voltage clamp circuit can be configured so that the time constant t causes the second switch to return to an off state within approximately 1 to 10 nanoseconds from when the input voltage no longer exceeds the desired output voltage signal by the threshold value.

The disclosure is also directed to a method for counteracting overvoltage events in a switching regulator including the steps of providing a switching regulator having an output with a desired voltage, sensing an overvoltage event at an input voltage of the switching regulator with a first RC timing circuit connected between the input voltage and ground, generating a switching signal when the overvoltage event exceeds a threshold value, and connecting the input voltage of the switching regulator to ground in response to the switching signal. Preferably, sensing an overvoltage event includes applying a desired output voltage signal from a junction of the RC timing circuit to a gate of a first switch connected between the input voltage and ground. Further, sensing an overvoltage event can also include maintaining the desired output voltage signal at a level corresponding to the desired voltage for a period of time dependent on a time constant of the first RC timing circuit. Also preferably, the first RC timing circuit has a time constant t within the range 0.1 to 100 microseconds.

Another aspect of the disclosure is directed to connecting the input voltage to ground by applying the switching signal to a gate of a second switch connected between the input voltage and ground. Preferably, the second switch disconnects the input voltage from ground after the overvoltage event. In such embodiments, disconnecting the input voltage preferably occurs within a time period in the range of approximately 1 to 10 nanoseconds after the overvoltage event no longer exceeds the threshold value.

In yet another aspect, a method of the disclosure includes the step of providing electrostatic discharge protection by increasing the time constant of the first RC timing circuit.

### BRIEF DESCRIPTION OF THE DRAWINGS

Further features and advantages will become apparent from the following and more particular description of the preferred embodiments of the invention, as illustrated in the accompanying drawing, and in which like referenced characters generally refer to the same parts or elements throughout the views, and in which:

FIG. 1 is a schematic diagram of the main functional components of a switching regulator, suitable for use with the invention;

FIG. 2 is a schematic diagram of the output stage of the switching regulator shown in FIG. 1, showing modeled parasitic inductance;

FIG. 3 is a graphical representation of voltage spikes in a conventional switching regulator;

FIG. 4 is a schematic diagram of voltage clamp suitable for use with a switching regulator; according to the invention; and

FIG. 5 is a graphical representation of voltage spikes in a switching regulator having a voltage clamp, according to the invention.

### DETAILED DESCRIPTION OF THE INVENTION

This disclosure involves methods and systems for minimizing overvoltage events in circuits such as switching regulators by draining current from a voltage source when voltage exceeding a desired level is generated.

At the outset, it is to be understood that this disclosure is not limited to particularly exemplified materials, methods or structures as such may, of course, vary. Thus, although a number of materials and methods similar or equivalent to those described herein can be used in the practice of embodiments of this disclosure, the preferred materials and methods are described herein.

It is also to be understood that the terminology used herein is for the purpose of describing particular embodiments of this disclosure only and is not intended to be limiting.

Unless defined otherwise, all technical and scientific terms used herein have the same meaning as commonly understood by one having ordinary skill in the art to which the disclosure pertains.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a digital processing system, or similar electronic computing device, that manipulates and transforms data represented as physical (electronic) quantities within the system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

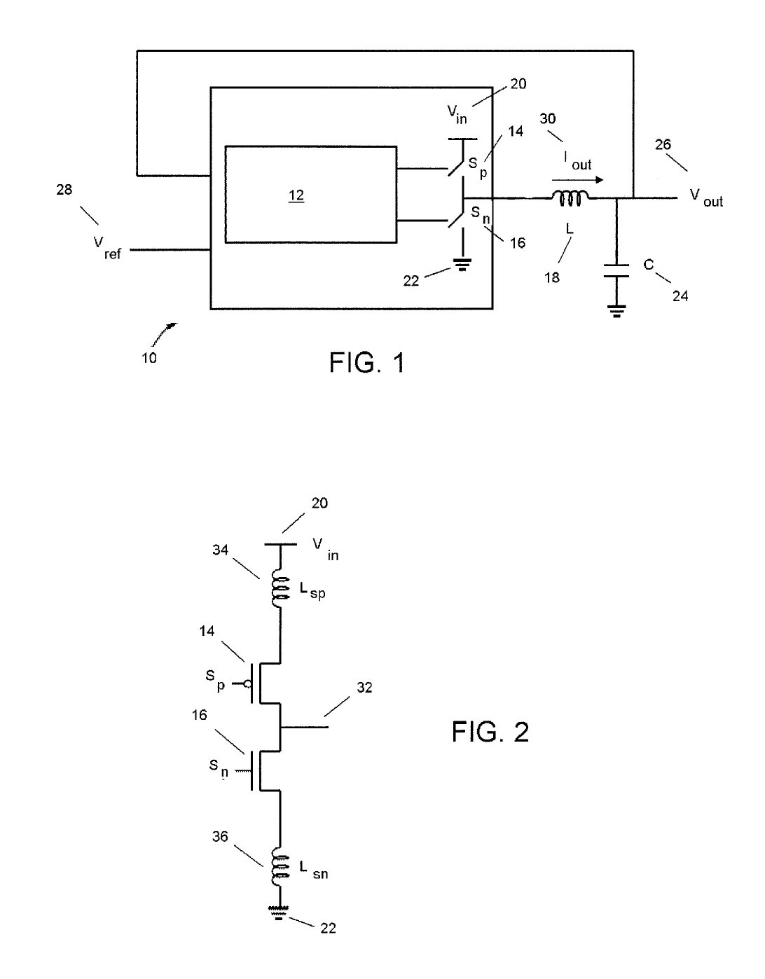

Turning now to FIG. 1, a switching regulator 10 suitable for integration in a digital CMOS circuit, such as a system-on-a-chip (SOC), is shown schematically in a configuration that provides an output voltage lower than the input voltage, also known as a buck converter. As will be appreciated, the techniques of this disclosure can be applied to other regulators, including boost, buck-boost, and others, as well as to other circuits that exhibit overvoltage events, such as power amplifiers, large digital output buffers, and the like. Controller 12 operates switches Sₚ 14 and Sₙ 16 to connect inductor L 18 either to the input voltage Vᵢₙ 20 or ground 22, respectively. Switches Sₚ 14 and Sₙ 16 are typically transistors responsive to control signals sent by controller 12, although other suitable switching systems or configurations can be used as desired. Capacitor C 24 acts as a voltage source to the load when inductor L 18 is charging to smooth the output. In some implementations, the controller 12 and switches Sₚ 14 and Sₙ 16 are integrated into the chip while the relatively large values required for inductor L 18 and capacitor C 24 mandate these components be wired individually, such as on the circuit board, rather than integrated into the CMOS package.

Controller 12 is driven by an oscillator or other suitable clock source, and under normal operation, connects inductor L 18 to Vᵢₙ 20 at the start of each clock cycle. Inductor L 18 and capacitor C 24 function as a low pass filter, providing an output voltage Vᵢₙ 26. An error signal generated by subtracting V_{ref} 28 from Vₒᵤₜ 26 is used to generate a proportional output current Iₒᵤₜ 30 across inductor L 18, driving Vₒᵤₜ 26 to approach V_{ref} 28. Feedback control to modulate the pulse width occurs when Iₒᵤₜ 30 reaches a current limit threshold. Controller 12 is configured with a comparator or other suitable circuitry to determine when the threshold current Iₗᵢₘ is met and then set switches Sₚ 14 and Sₙ 16 to connect inductor L 18 to ground 22.

As will be appreciated by one of skill in the art, parasitic inductance in switching regulator 10 can result from a variety of sources, including the bond wires, the package of the CMOS circuitry and the board traces. FIG. 2 schematically represents the output stage of switching regulator 10, where output 32 connects to inductor L 18 (not shown in FIG. 2). Lₛₚ 34 models the parasitic inductance resulting from switch Sₚ 14 connecting to Vᵢₙ 20 and Lₛₙ 36 models the parasitic inductance resulting from switch Sₙ 16 connecting to ground 22.

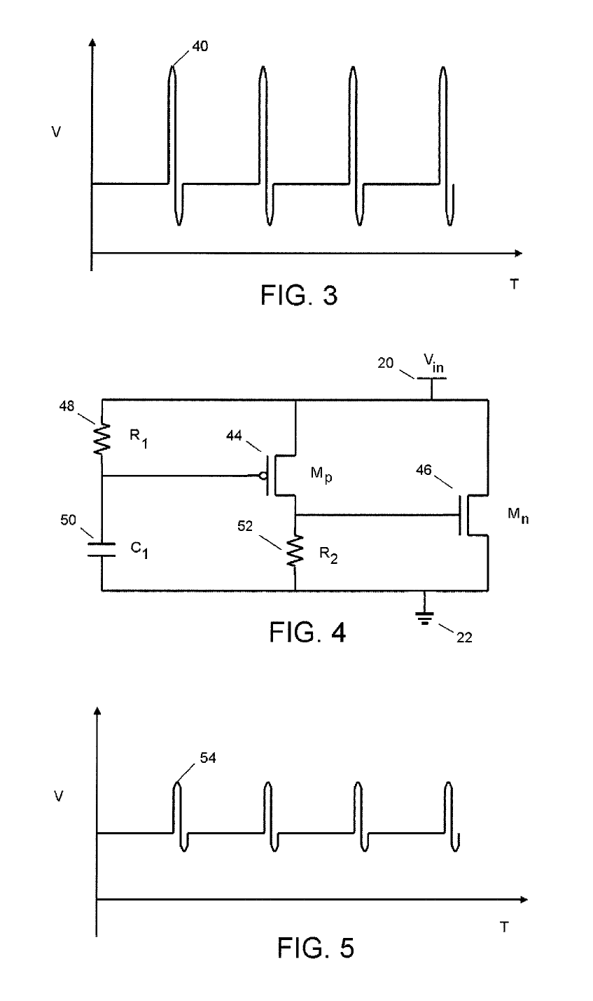

Voltage overshoots, spikes or other overvoltage events generated by these parasitic inductances can be attributed to two primary characteristics. First, when the voltage at the gates of switches Sₚ 14 and Sₙ 16 changes from Vᵢₙ 20 to ground 22, the charge of the parasitic capacitances of the transistors is injected to parasitic supply inductance. Second, when switches Sₚ 14 and Sₙ 16 transition from an on state to an off state, the large load current that is running through them is interrupted, but the current running through the parasitic inductances Lₛₚ 34 and Lₛₙ 36 does not stop instantaneously. The continued flow of current through the parasitic inductance charges the parasitic capacitance at the device sources to a very high or very low value. As will be appreciated, both of these conditions result in voltage overshoots equal to the amount of parasitic inductance multiplied by the rate of change of the current. FIG. 3 graphically represents the output voltage of switching regulator 10 having a plurality of voltage spikes 40 that correlate with each switching event. For example, for a load current in the range of approximately 0.5 to 1.2 A, a typical parasitic inductance value can result in disrupting or damaging overvoltages of approximately 8 V.

To minimize voltage spikes 40, a voltage clamp circuit 42 is incorporated into switching regulator 10. One embodiment of voltage clamp 42 is schematically shown in FIG. 4. Generally, the source of switch Mₚ 44 is connected to the input voltage Vᵢₙ 20 of the clamp and the drain is connected to the gate of switch Mₙ 46, which is connected between Vᵢₙ 20 and ground 22. A first RC timing circuit is formed by resistor R₁ 48 and capacitor C 50 so that the gate of switch Mₚ 44 will be held at a voltage corresponding to the desired voltage of Vᵢₙ 20 for a suitable length of time, as will be described below. The drain of switch Mₚ 44 is connected by resistor R₂ 52 to ground 22, forming an inverter configuration that controls the gate of switch Mₙ 46. In the embodiment shown, switch Mₚ 44 is a p-channel switch and switch Mₙ 46 is an n-channel switch. Suitable switches include metal oxide semiconductor field effect transistors (MOSFETs), and other analogous transistors including insulated gate FETs (IGFETs), metal insulator semiconductor FETs (MISFETs), although one of skill in the art will recognize that other transistor designs or other switching technologies can be employed as desired.

In operation, capacitor C 50 is charged to the desired nominal voltage of Vᵢₙ 20, and this voltage is applied to the gate of switch Mₚ 44 from the node of the RC timing circuit between resistor R₁ 48 and capacitor C 50, placing it in an off state with due to an equal voltage applied to the source. Since little current flows through Mₚ 44 when off, the gate of Mₙ 46 is at ground, placing Mₙ 46 in an off state so that current from Vᵢₙ 20 is not sunk through switch Mₙ 46 to ground 22. When a voltage spike develops in Vᵢₙ 20, the gate of Mₚ 44 remains at the nominal Vᵢₙ for a period of time due to this RC timing circuit. If the voltage spike overcomes the nominal voltage at the gate by a threshold value, current will flow from the Vᵢₙ 20 source to the drain of Mₚ 44, triggering the gate of switch Mₙ 46. Once switch Mₙ 46 is turned on, it will drain current from Vᵢₙ 20 to ground 22, counteracting the overvoltage event by attenuating the voltage spike developed in Vᵢₙ 20.

FIG. 5 illustrates the voltage output waveform of switching regulator 10 equipped with voltage clamp circuit 42. As can be seen, the voltage spikes 54 created at each switching event are significantly reduced as compared to the voltage spikes 40 shown in FIG. 3 that result from a switching regulator without voltage clamp circuit 42.

As discussed above, the first RC timing circuit is used to sense the overvoltage events by holding the gate of Mp 44 at a voltage that corresponds to the desired output voltage of switching regulator 10, thus providing a signal corresponding to the desired output voltage, the nominal output of switching regulator 10. With this configuration, when a voltage spike occurs in Vᵢₙ 20, the differential between the source voltage and the gate voltage is sufficient to overcome the threshold value of the switch, so that the gate of Mₚ 44 is brought low and current can flow through Mₚ 44 to generate a switching signal in the form of voltage at the gate of Mₙ 46, switching it on to drain current from the voltage supply to ground.

By selecting appropriate values for the components of the first RC timing circuit, voltage clamp 42 can be tuned to provide the desired level of voltage overshoot protection. As discussed, a first attribute is providing sufficient delay in the desired voltage signal at the gate of Mₚ 44 so that a voltage differential can develop when a voltage spike occurs in Vᵢₙ 20. If the delay is not sufficient, the voltage at the gate of Mₚ 44 tracks the transient voltage of Vᵢₙ 20 and is never brought low, maintaining Mₚ 44 in an off state and preventing switch Mₙ 46 from draining current to minimize the voltage overshoot.

RC timing circuits have a time constant t equal to the resistance multiplied by the capacitance. In one embodiment of the disclosure, the values for resistor R₁ 48 and capacitor C 50 are preferably chosen to provide a time constant tailored to the duration of the voltage overshoots of switching regulator 10. For example, suitable time constants for such applications can be in the range of approximately 0.1 to 100 microseconds, and more preferably in the range of approximately 10 to 100 microseconds. Correspondingly, representative values for resistor R₁ 48 are in the range of approximately 10 to 100 Kohms and representative values of capacitor C 50 are in the range of approximately 10 to 100 picofarads.

Also preferably, voltage clamp circuit 42 is configured so that switch Mₙ 46 minimizes the period of time during which current from Vᵢₙ 20 is drained to ground when an overvoltage event is not occurring. Specifically, Mₙ 46 preferably returns to an off state as quickly as possible once the voltage on Vᵢₙ 20 no longer exceeds the threshold value. A second RC timing circuit formed by the gate capacitance of switch Mₚ 44 and resistor R₂ also has a time constant t. As such, suitable values for resistor R₂ 52 and the characteristics of switch Mₚ 44 are chosen to ensure that switch Mₙ 46 rapidly reverts to an off state once the voltage spike passes. Since operation of switch Mₙ 46 drains current to ground, it represents power dissipation from the circuit that should be minimized when not necessary to provide overvoltage protection. Thus, for applications such as switching regulator 10, the time constant t for the second RC timing circuit is preferably less than approximately 10 nanoseconds. Corresponding representative values for resistor R₂ 52 are in the range of approximately 50 to 500 ohms.

In addition, the techniques of this disclosure can be extended to offer electrostatic discharge (ESD) protection in addition to the protection from overvoltage events caused by parasitic aspects of the circuit. Preferably, such protection can be achieved by increasing the time constant of the first RC timing circuit. As one of skill in the art will recognize, it is still desirable to minimize the time constant of the second RC timing circuit to reduce the inefficiency associated with draining the input voltage to ground for longer periods of time than necessary.

Described herein are presently preferred embodiments, however, one skilled in the art that pertains to the present invention will understand that the principles of this disclosure can be extended easily with appropriate modifications to other applications.

What is claimed is:

1. A switching regulator having an output with a desired voltage and a voltage clamp circuit, wherein the voltage clamp circuit comprises a first RC timing circuit connecting a voltage input to ground, a first switch connected to the input that is configured to be controlled by a desired output voltage signal from the first RC timing circuit such that the first switch is in an off state when the voltage input is balanced by the desired output voltage signal from the first RC timing circuit and is in an on state that generates a switching signal when the voltage input exceeds the desired output voltage signal by a threshold value, and a second switch that sinks current from the input to ground when placed in an on state by the switching signal.

2. The switching regulator of claim 1, wherein the first switch is a p-channel MOSFET and the second switch is an n-channel MOSFET.

3. The switching regulator of claim 1, wherein the first RC timing circuit is formed by a first resistor and a capacitor connected in series between the input voltage and ground and wherein the desired output voltage signal is taken from a node of the first resistor and capacitor.

4. The switching regulator of claim 1, wherein the first RC timing circuit has a time constant t within the range of approximately 0.1 to 100 microseconds.

5. The switching regulator of claim 4, wherein the switching regulator has a switching period and wherein the time constant t is in the range of approximately 10 to 100 times the switching period.

6. The switching regulator of claim 1, further comprising a second RC timing circuit formed by a second resistor connecting a drain of the first switch to ground.

7. The switching regulator of claim 6, wherein the second RC timing circuit has a time constant t related to the second resistor and a gate capacitance of the first switch.

8. The switching regulator of claim 7, wherein the time constant t is in the range of approximately 1 to 10 nanoseconds.

9. The switching regulator of claim 7, wherein the time constant t causes the second switch to return to an off state within approximately 1 to 10 nanoseconds from when the input voltage no longer exceeds the desired output voltage signal by the threshold value.

10. A method for minimizing overvoltage events in a switching regulator comprising the steps of:
a) providing a switching regulator having an output with a desired voltage;
b) sensing an overvoltage event at an input voltage of the switching regulator with a first RC timing circuit connected between the input voltage and ground;
c) generating a switching signal when the overvoltage event exceeds a threshold value; and
d) connecting the input voltage of the switching regulator to ground in response to the switching signal.

11. The method of claim 10, wherein the step of sensing an overvoltage event comprises applying a desired output voltage signal from a node of the RC timing circuit to a gate of a first switch connected between the input voltage and ground.

12. The method of claim 11, wherein the step of sensing an overvoltage event further comprises maintaining the desired output voltage signal at a level corresponding to the desired voltage for a period of time dependent on a time constant of the first RC timing circuit.

13. The method of claim 12, wherein the period of time is in the range of approximately 1 to 10 nanoseconds.

14. The method of claim 12, wherein the switching regulator has a switching period and wherein the period of time is approximately 10 to 100 times the switching period.

15. The method of claim 10, wherein the step of connecting the input voltage of the switching regulator to ground comprises applying the switching signal to a gate of a second switch connected between the input voltage and ground.

16. The method of claim 15, further comprising the step of disconnecting the input voltage from ground when the overvoltage event no longer exceeds the threshold value.

17. The method of claim 16, wherein the step of disconnecting the input voltage from ground occurs within a time period in the range of approximately 1 to 10 nanoseconds after the overvoltage event no longer exceeds the threshold value.

18. The method of claim 12, further comprising the step of providing electrostatic discharge protection by increasing the time constant.
